(19) United States
(12) Patent Application Publication
(10) Pub. No.: US 2020/0128999 A1
(43) Pub. Date: Apr. 30, 2020

(54) Kettle craftwork

(71) Applicant: Caiqiao Chen, Wuhan City (CN)

(72) Inventor: Caiqiao Chen, Wuhan City (CN)

(21) Appl. No.: 16/732,347

(22) Filed: Jan. 2, 2020

(30) Foreign Application Priority Data
May 6, 2019 (CN) 2019103715780

(51) Int. Cl. A47J 27/21; B05B 1/12

(52) U.S. Cl. CPC A47J 27/21191; B05B 1/12

(57) ABSTRACT

The invention discloses a kettle craftwork, which includes a kettle body and a kettle base. The kettle body is provided with an oval groove. The kettle base is provided with a bottom groove with an opening facing downward. The bottom groove is provided with a flow rate adjustment mechanism. The flow velocity adjusting mechanism includes a ring groove located on an outer end wall of the bottom groove, and a horizontal block located in the bottom groove near one end of the bottom groove is slidably provided in the ring groove, and two of the lateral blocks There is a bottom plate fixed between the rooms.

### CROSS-REFERENCES TO RELATED APPLICATIONS

The present application claims priority from Chinese application No. 2019103715780 filed on May 6, 2019 which is hereby incorporated by reference in its entirety.

### FIELD OF TECHNOLOGY

The invention relates to the field of crafts, and in particular relates to a kettle craftwork.

### TECHNICAL FIELD

Kettle crafts are a kind of daily necessities with hand-made steps. The existing kettle crafts have simple functions, and most of them only have water storage and decoration functions. In a society with diversified living needs, there are more requirements for watering methods of kettle, Traditional kettles cannot meet many requirements.

### CONTENT OF THE INVENTION

The purpose of the present invention is to provide a kettle craftwork to solve the problems mentioned in the background art mentioned above.

In order to achieve the above object, the present invention provides the following technical solution: a kettle craftwork including a kettle body and a kettle base, the kettle body is provided with an oval groove, and the kettle base is provided with a bottom groove facing downward, A flow velocity adjusting mechanism is provided in the bottom groove, and the flow velocity adjusting mechanism includes a ring groove located on an outer end wall of the bottom groove, and an end close to the bottom groove is slidably arranged in the ring groove and is located in the bottom groove. A bottom plate is fixed between the two lateral blocks, a rotating block is fixed on the lower end surface of the bottom plate, and a rotating shaft is fixedly connected to the upper end wall of the bottom groove. The left end wall of the oval groove is provided with a storage slot opening to the left, and a water column type water outlet mechanism is provided in the storage slot. The water column type water outlet mechanism includes a storage block fixedly connected to the right end wall of the storage tank. A square groove is provided in the storage block, and a left end wall of the square groove is provided with an elastic groove with a right end wall communicating with the square groove. A magnet plate is slidably arranged in the elastic groove, and the left end surface of the magnet plate faces up and down. An elastic spring with a left end fixedly connected to the left end wall of the elastic groove is fixedly provided, and a water pipe communicating with the square groove is wound on the storage block, a water jet is installed at the left end of the water pipe, and a right end of the water jet A first magnet is fixedly provided, a vertical groove is provided in the right end wall of the oval groove, a lateral spring is fixed in the left end wall of the vertical groove, and a right end of the lateral spring is fixed in sliding connection with the vertical groove. A hollow rod, the right end of the hollow rod is located in the outer space and a pressure block is fixed, a second magnet is embedded in the hollow rod, and a long groove is formed in the pressure block to penetrate the upper and lower end surfaces of the pressure block. A cylindrical groove is provided at the rear end wall of the long groove, and four short grooves are evenly distributed at the outer end wall of the cylindrical groove. A cylindrical shaft is provided at the rear wall of the cylindrical groove, and an opening is provided in the cylindrical shaft. An elastic groove facing to the right, an elastic spring is fixed at the left end wall of the elastic groove, an elastic block with a right end located in the short groove is fixed at the right end of the elastic spring, and a long rod and a transmission gear are fixed on the cylindrical shaft. The transmission gear is located in the The front side of the rod.

Preferably, the flow rate adjusting mechanism further includes a left-right symmetrical lifting groove, the left-side lifting groove communicates with the square groove through a drainage groove, and an end wall of the lifting groove close to the oval groove communicates with the oval groove The upper end of the rotating shaft is located in the oval groove and is fixed with a thread block. The thread block is internally connected with a threaded rod. The lifting groove is slidably provided with a lifting rod. The lifting rod is close to the oval. An end surface of the groove is fixedly connected with an upper end surface of the threaded rod through a support rod.

Preferably, a ratchet block is installed on the rear wall of the vertical groove, a switch groove is provided on the upper end wall of the oval groove, a switch block is screw-threaded in the switch groove, and the upper end surface of the kettle body is symmetrically hinged to the left and right. Two handles.

Preferably, a water outlet is provided at the right end wall of the lifting groove on the right side, a vertical groove is provided at the lower end wall of the water outlet, a vertical spring is fixed at the lower end wall of the vertical groove, and an upper end of the vertical spring is fixed at There is a third magnet, a water blocking plate slidingly connected to the vertical groove is fixed on the upper end of the third magnet, and an inclined water pipe communicating with the water outlet is fixed on the right end of the pot body, and the right end of the inclined water pipe is fixed A dispersion nozzle connected to the inclined water pipe is fixed on the surface, and a drainage hole is provided on the right end surface of the dispersion nozzle.

To sum up, the present invention has the beneficial effects that the device can store water, can be adjusted to a distributed water outlet function when uniform watering such as watering is required, and can be adjusted to a water pipe when concentrated rainwater activities such as washing are required. The water outlet function can be more convenient for flushing, and the water outlet speed can be adjusted to meet the various needs of users.

### BRIEF DESCRIPTION OF THE DRAWINGS

The present invention is described in detail below with reference to FIGS. 1-6. For convenience of description, the orientation described below is defined as follows: the up-down, left-right, front-back direction described below is consistent with the up-down, left-right, front-back direction of the projection relationship of FIG. 1 itself.

FIG. 1 is a schematic diagram of a full-cut structure of a kettle craftwork;

FIG. 2 is a schematic diagram at C in FIG. 1;

FIG. 3 is a schematic diagram of the direction A-A in FIG. 2;

FIG. 4 is a schematic diagram of the D-D direction in FIG. 3;

FIG. 5 is a schematic diagram of a direction B in FIG. 1;

FIG. 6 is an enlarged schematic view at E in FIG. 1.

### DETAILED DESCRIPTION OF THE INVENTION

All features disclosed in this specification, or all disclosed methods or steps, other than mutually exclusive features and/or steps, may be combined in any manner.

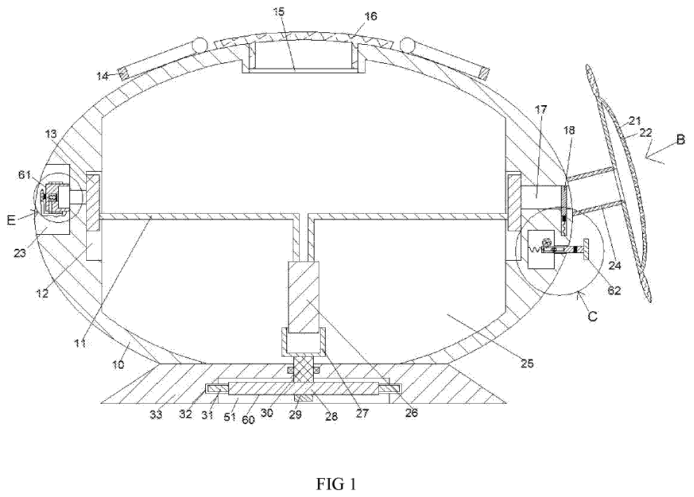

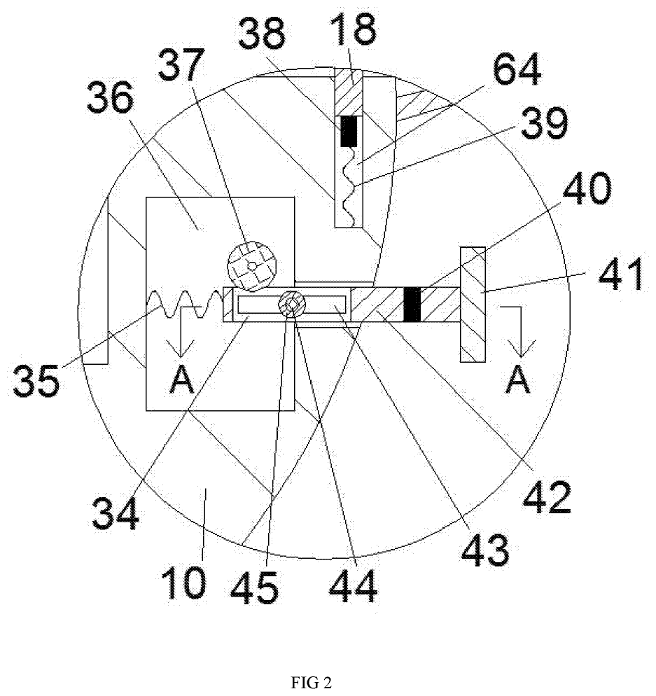

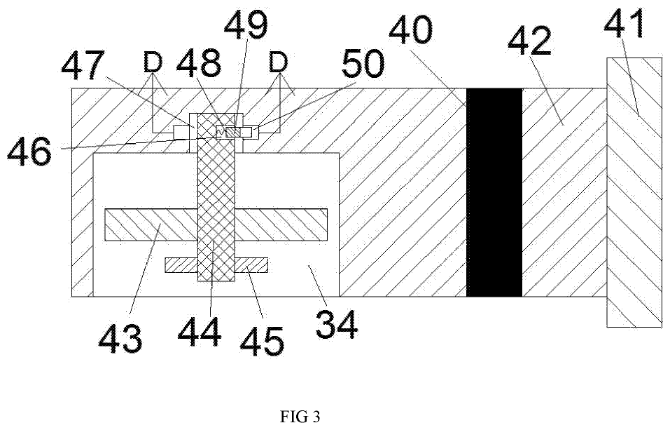

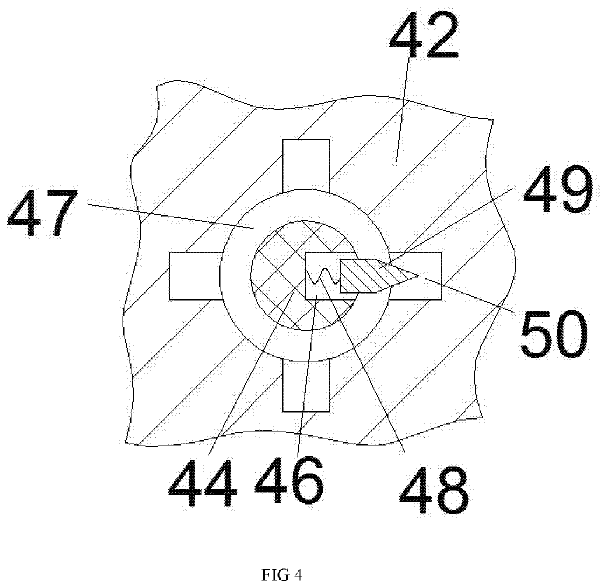

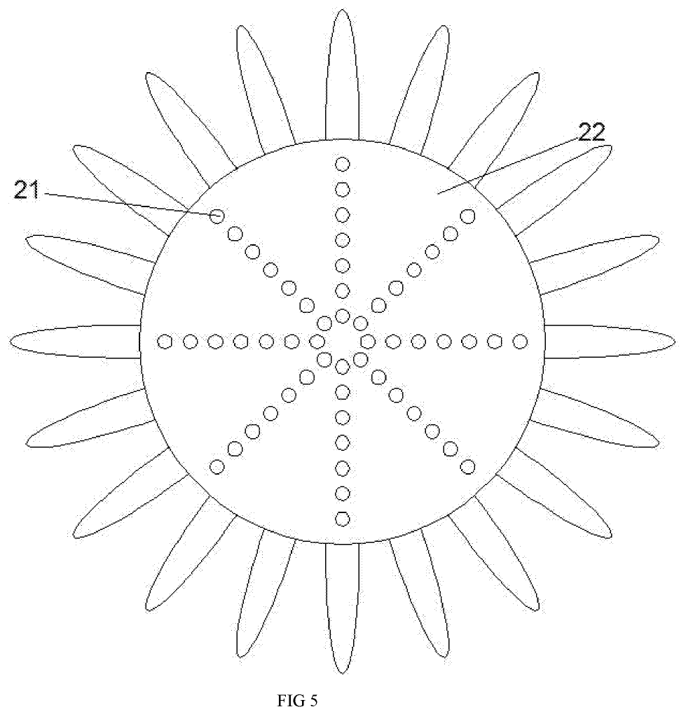

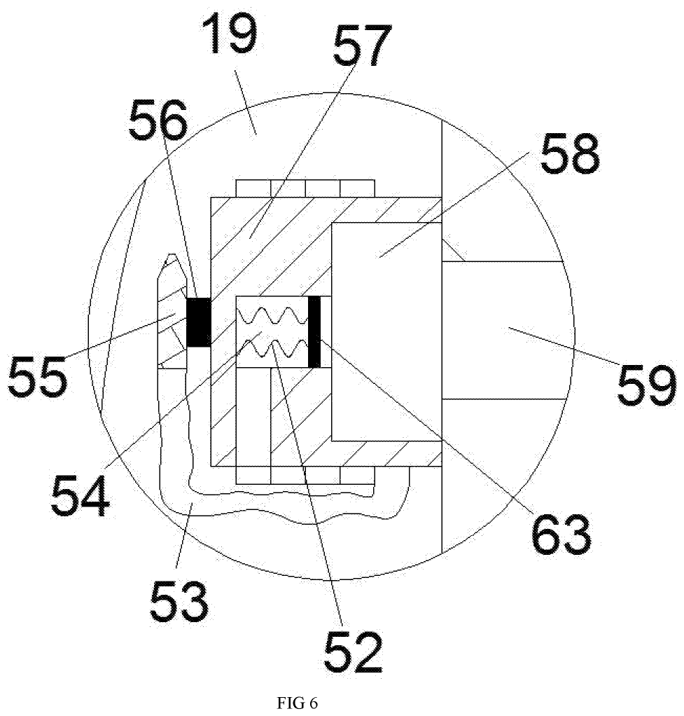

Please refer to FIGS. 1-6. An embodiment of the present invention provides a kettle craftwork, including a kettle body 10 and a kettle base 33. The kettle body 10 is provided with an oval groove 25 therein, and the kettle base 33 is provided therein. There is a bottom groove 51 with an opening facing downward, and a flow velocity adjusting mechanism 60 is provided in the bottom groove 51. The flow velocity adjusting mechanism 60 includes a ring groove 32 located on the outer end wall of the bottom groove 51. A horizontal block 31 located in the bottom groove 51 near one end of the bottom groove 51 is symmetrically slid. A bottom plate 28 is fixed between the two lateral blocks 31, and a lower end surface of the bottom plate 28 is fixed. A rotating block 29 is provided on the upper end of the rotating block 29 with a rotating shaft 30 rotatably connected to the upper end wall of the bottom groove 51. A left end wall of the elliptical groove 25 is provided with a storage groove 19 opening to the left. A water column type water outlet mechanism 61 is provided in the tank 19, and the water column type water outlet mechanism 61 includes a storage block 57 fixedly connected to the right end wall of the storage tank 19. The storage block 57 is provided with a square groove 58 therein. 58 The left end wall is provided with an elastic groove 54 having a right end wall communicating with the square groove 58, and the elasticity A magnet plate 63 is slidably arranged in 54. The left end surface of the magnet plate 63 is symmetrically fixed with an elastic spring 52 at the left end fixedly connected to the left end wall of the elastic groove 54. The storage block 57 is wound with the square groove. A water pipe 53 of 58 is provided with a water jet head 55 at the left end of the water pipe 53. A first magnet 56 is fixedly located on the right end face of the water pipe 55. The first magnet 56 is attracted to the magnet plate 63, so that The elastic spring 52 is compressed. A vertical groove 36 is provided in the right end wall of the oval groove 25. A lateral spring 35 is fixed on the left end wall of the vertical groove 36. The right end of the lateral spring 35 is fixed on the right end. The vertical groove 36 is a hollow rod 42 slidably connected. The right end of the hollow rod 42 is located in the outer space and a pressure block 41 is fixedly installed. The hollow rod 42 is embedded with a second magnet 40 and the pressure block 41 is provided with A long groove 34 running through the upper and lower end surfaces of the pressure block 41 is provided with a cylindrical groove 47 at the rear wall of the long groove 34, and four short grooves 50 are evenly distributed at the outer end wall of the cylindrical groove 47. A cylindrical shaft 44 is provided at the rear end wall of the groove 47, and the cylindrical shaft 44 is provided with an elastic force opening to the right. 46, an elastic spring 48 is fixed on the left end wall of the elastic groove 46, an elastic block 49 with a right end located in the short groove 50 is fixed on the right end of the elastic spring 48, and a long rod 43 is fixed on the cylindrical shaft 44 With the transmission gear 45, the transmission gear 45 is located on the front side of the long rod 43.

Advantageously, the flow rate adjustment mechanism 60 further includes a left-right symmetrical lifting groove 12, the left-side lifting groove 12 communicates with the square groove 58 through a drainage groove 59, and the lifting groove 12 is near an end of the oval groove 25. The wall communicates with the oval groove 25, and the upper end of the rotation shaft 30 is located in the oval groove 25 and is fixedly provided with a thread block 27. The thread block 27 is internally screwed with a threaded rod 26, and the threaded block 27 rotates. The threaded rod 26 can be driven to move up and down. A lifting rod 13 is slidably arranged in the lifting groove 12. An end surface of the lifting rod 13 near the oval groove 25 and an upper end surface of the threaded rod 26 pass through the support rod 11. Fixed connection.

Beneficially, a ratchet block 37 is installed at the rear wall of the vertical groove 36. When the transmission gear 45 moves to the left to mesh with the ratchet block 37, the ratchet block 37 can drive the transmission gear 45 to rotate. When the transmission gear 45 moves to the right and meshes with the ratchet block 37, the transmission gear 45 does not move. The upper end wall of the oval groove 25 is provided with a switch groove 15. The switch groove 15 is internally connected with a switch. Block 16, two handles 14 are connected to the left and right sides of the pot body 10 symmetrically and hingedly.

Beneficially, a water outlet 17 is provided on the right end wall of the lifting groove 12 on the right side, a vertical groove 64 is provided on the lower end wall of the water outlet 17, and a vertical spring 39 is fixed on the lower end wall of the vertical groove 64. The upper end of the vertical spring 39 is fixedly provided with a third magnet 38, and the upper end of the third magnet 38 is fixedly provided with a water blocking plate 18 slidingly connected to the vertical groove 64. The third magnet 38 and the second magnet are fixed. There is an attractive force between 40. When the second magnet 40 moves to the lower side of the third magnet 38, the second magnet 40 can attract the third magnet 38 to move downward. The right end surface of the pot body 10 is fixedly provided. The inclined water pipe 24 communicating with the water outlet 17 is fixedly provided with a dispersion nozzle 22 communicating with the inclined water pipe 24 at a right end surface thereof, and a drainage hole 21 is provided at a right end surface of the dispersion nozzle 22.

In the following, the applicant will refer to the accompanying drawings 1-6 and the specific composition of a kettle craftwork of the present application described above to describe in detail the method of using a kettle craftwork of the present application:

The rotary switch block 16 can add or pour water into the oval groove 25. Rotate the rotary block 29 to drive the screw block 27 to rotate. The screw connection between the screw block 27 and the screw rod 26 can drive the screw rod 26 to move up and down, thereby driving the lifting rod. 13 Lifting in the lifting tank 12 to achieve the effect of adjusting the water speed of the device;

When a water column effect is needed, the spray head 55 is pulled to drive the first magnet 56 away from the magnet plate 63. The magnet plate 63 is reduced by the attractive force of the first magnet 56 and the elastic spring 52 is reset to push the magnet plate 63 into the square groove. 58, at this time, by lifting the pot body 10 by the handle 14, the water in the oval groove 25 can be poured out from the sprinkler 55, and the distance of the water can be adjusted by retracting the water pipe 53;

When the decentralized water outlet effect is needed, push the pressure block 41 to the left and drive the transmission gear 45 to rotate 90 degrees through the meshing transmission of the transmission gear 45 and the ratchet block 37, thereby driving the long rod 43 to rotate 90 degrees, so that the long rod 43 is blocked by the vertical groove 36, and the second magnet 40 is located directly below the third magnet 38, which attracts the third magnet 38 to descend, and drives the water blocking plate 18 to descend, so that the inclined water pipe 24 and the oval groove 25 communicate with each other through the water outlet 17. The water in the oval groove 25 can be poured out through the drainage hole 21 to form a dispersed water flow.

The beneficial effect of the invention is that the device is a ceramic handicraft, which can store water inside, and can be adjusted to a distributed water outlet function when uniform watering such as watering is required, and can be adjusted to a centralized rainwater activity such as washing. The water outlet function with a water pipe can be more convenient for flushing, and the water outlet speed can be adjusted to meet the various needs of users.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A kettle craftwork, comprising a kettle body and a kettle base, is characterized in that: an oval groove is provided in the kettle body, a bottom groove with an opening facing downward is provided in the kettle base, and a flow velocity adjusting mechanism is provided in the bottom groove The flow rate adjusting mechanism includes a ring groove located on an outer end wall of the bottom groove, and a lateral block located in the bottom groove adjacent to the bottom groove is slid symmetrically in the ring groove. A bottom plate is fixedly arranged between the transverse blocks, a rotary block is fixedly arranged on the lower end surface of the bottom plate, a rotary shaft is fixedly connected to the upper end wall of the bottom groove, and a left end wall of the oval groove is fixed. A storage slot with an opening facing to the left is provided. The storage slot is provided with a water column type water outlet mechanism. The water column type water outlet mechanism includes a storage block fixedly connected to the right end wall of the storage tank. The storage block is provided with a square. The left end wall of the square groove is provided with an elastic groove with a right end wall communicating with the square groove. A magnet plate is slidably arranged in the elastic groove. An elastic spring fixedly connected to the end wall, a water pipe communicating with the square groove is wound on the storage block, a water jet is installed at the left end of the water pipe, and a first magnet is fixed at the right end of the water jet, and the ellipse A vertical groove is provided in the right end wall of the shaped groove, and a lateral spring is fixed on the left end wall of the vertical groove. A hollow rod slidingly connected to the vertical groove is fixed on the right end of the horizontal spring. A pressure block is fixed in the external space, and a second magnet is embedded in the hollow rod. A long groove is formed in the pressure block and penetrates the upper and lower end faces of the pressure block. The rear end wall of the long groove is provided with a cylindrical shape. Grooves, four short grooves are evenly distributed on the outer end wall of the cylindrical groove, a cylindrical shaft is provided at the rear end wall of the cylindrical groove, and an elastic groove with an opening to the right is provided in the cylindrical shaft, and the elastic groove An elastic spring is fixed on the left end wall, and an elastic block with the right end in the short groove is fixed on the right end of the elastic spring. A long rod and a transmission gear are fixed on the cylindrical shaft, and the transmission gear is located on the long rod. Front side.

2. The kettle craftwork according to claim 1, wherein the flow rate adjusting mechanism further comprises a left-right symmetrical lifting groove, the left-side lifting groove communicates with the square groove through a drainage groove, and the lifting groove is near An end wall of the oval groove communicates with the oval groove, and an upper end of the rotation shaft is located in the oval groove and a thread block is fixed. The thread block is internally connected with a threaded rod, and the lifting groove slides A lifting rod is provided, and an end surface of the lifting rod near the oval groove is fixedly connected with an upper end surface of the threaded rod through a support rod.

3. The kettle craftwork according to claim 1, characterized in that: a ratchet block is installed at the rear end wall of the vertical slot, a switch slot is provided at the upper end wall of the oval slot, and a switch is screwed in the switch slot Block, the upper end surface of the pot body is symmetrically hingedly connected with two handles.

4. The kettle craftwork according to claim 1, characterized in that: a right end wall of the lifting groove is provided with a water outlet, a lower end wall of the water outlet is provided with a vertical groove, and a lower end wall of the vertical groove is fixedly provided There is a vertical spring, a third magnet is fixed at the upper end of the vertical spring, a water retaining plate slidingly connected to the vertical groove is fixed at the upper end of the third magnet, and a right end of the kettle body is fixedly connected. In the inclined water pipe of the water outlet, the right end face of the inclined water pipe is fixedly provided with a dispersion nozzle connected to the inclined water pipe, and the right end face of the dispersion nozzle is provided with a drainage hole.
